(19) United States
(12) Patent Application Publication
(10) Pub. No.: US 2016/0033051 A1
(43) Pub. Date: Feb. 4, 2016

(54) SHUTOFF VALVE ASSEMBLY

(71) Applicant: Parker-Hannifin Corporation, Cleveland, OH (US)

(72) Inventor: Vincenzo Barbato, Richmond, TX (US)

(21) Appl. No.: 14/447,743

(22) Filed: Jul. 31, 2014

(51) Int. Cl. F16K 17/34

(52) U.S. Cl. CPC F16K 17/34

(57) ABSTRACT

A shutoff valve assembly includes a shutoff valve, an extension tube extending from the shutoff valve and an excess flow valve located at a lower end of the extension tube. The excess flow valve includes a valve member in a normally open position and responsive to flow into the excess flow valve to close the excess flow valve. A tubular body of the excess flow valve receives the valve member and defines a radial gap between an inner diameter of the tubular body and an outer diameter of the valve member, where the radial gap is uniform over an axial distance between the open position and a closed position of the valve member. The shutoff valve assembly may be used in combination with a fluid storage tank for storing fluid and an excess flow valve inlet may be disposed adjacent an internal bottom surface of the tank.

### FIELD OF INVENTION

The present invention relates generally to shutoff valve assemblies, and more particularly to a shutoff valve assembly having a closing flow rate with a reduced flow rate tolerance for use in anhydrous ammonia delivery systems.

### BACKGROUND

Anhydrous ammonia may be applied to soil by farmers as a fertilizer. Farmers often use a nurse tank containing pressurized liquid anhydrous ammonia as a source. The nurse tank may be stationary and used to fill an intermediary tank, or the nurse tank may be provided on a cart that is transported by a farm vehicle across a field while the anhydrous ammonia is distributed to the soil via a tool bar connected to the nurse tank. To draw anhydrous ammonia from the nurse tank, a delivery hose is connected to a shutoff valve assembly of the nurse tank for stopping uncontrolled release of anhydrous ammonia fluid (gas, liquid, or a combination thereof) in the case of a downstream line break.

Shutoff valve assemblies of fluid delivery systems remain in an open position during normal operation. When an excess flow condition occurs downstream of a shutoff valve assembly, increased flow through the shutoff valve assembly creates an increased pressure drop across a valve member of the shutoff valve assembly. The valve member is caused to move to overcome a biasing force acting on the valve member, thereby closing the shutoff valve assembly. The shutoff valve assembly typically may re-open upon pressure equalization between pressures on opposite sides of the valve member.

Operational and safety requirements associated with shutoff valve assemblies necessitate that a shutoff valve assembly be capable of repeatedly closing at a substantially consistent flow rate and that the flow rate at which the valve assembly closes have a small tolerance range. The closing rate of the shutoff valve assembly must be substantially uniform upon occurrence of flow sufficient to close the valve assembly flowing therethrough. The valve assembly must also be substantially unaffected by a flash interface between liquid and gas phases of a fluid, such as anhydrous ammonia.

### SUMMARY OF INVENTION

A shutoff valve assembly is provided to address these requirements and includes a shutoff valve, an extension tube extending from the shutoff valve and an excess flow valve located at a lower end of the extension tube. The excess flow valve includes a valve member in a normally open position and responsive to flow into the excess flow valve to close the excess flow valve. A tubular body of the excess flow valve receives the valve member, and defines a radial gap between an inner diameter of the tubular body and an outer diameter of the valve member, where the radial gap is uniform over an axial distance between the open position and a closed position of the valve member. The shutoff valve assembly may be used in combination with a fluid storage tank for storing fluid and an excess flow valve inlet may be disposed adjacent an internal bottom surface of the tank.

According to one aspect, a shutoff valve assembly includes a shutoff valve including a main valve body having a main inlet end and a main outlet end and defining a main flow passage therebetween, and a valve member for opening and closing the main flow passage. The shutoff valve assembly also includes an extension tube extending between an upper end and a lower end and an excess flow valve located at the lower end of the extension tube. The excess flow valve includes a valve member in a normally open position and responsive to flow through the excess flow valve, the valve member being movable along a valve member axis to a closed position at a prescribed amount of flow across the valve member to close the excess flow valve.

The excess flow valve may further include a tubular body coupled to the extension tube and having the valve member disposed therein.

An inlet end of the tubular body may extend along the valve member axis beyond the open position of the valve member.

The excess flow valve may be removably coupled to the extension tube, and may be preferably threadedly coupled to the extension tube.

The extension tube may be removably coupled to the shutoff valve, and may be preferably threadedly coupled to the shutoff valve.

The main valve body may include a tubular collar having external main threads for engaging a fluid storage tank, and internal main threads for engaging the extension tube.

The shutoff valve assembly may be in combination with a fluid storage tank for storing fluid, wherein the extension tube is configured such that an inlet end of the excess flow valve is disposed adjacent an internal bottom surface of the fluid storage tank.

The excess flow valve may further include an annular valve seat disposed in the tubular body and defining an inner passage for directing flow through the tubular body, and a first cross-sectional area between an outer diameter of the valve member and an inner diameter of the tubular body at the open position of the valve member may be greater than a smallest second cross-sectional area through the inner passage at the open position of the valve member.

The excess flow valve may further include an annular valve seat disposed in the tubular body and defining an inner passage for directing flow through the tubular body, and a first cross-sectional area between an outer diameter of the valve member and an inner diameter of the tubular body at the open position of the valve member may remain uniform over an axial distance between the open position and the closed position at least until a third cross-sectional area between the outer diameter of the valve member and an inner diameter of the valve seat equals the first cross-sectional area.

The tubular body may be cylindrical, and the inner diameter of the tubular body may be uniform over an axial distance between the open position and the closed position.

The shutoff valve assembly may further include an annular valve seat, the valve member being movable relative to the valve seat and engaging the valve seat at the closed position, a hub having a central guide for guiding the valve member, and a tubular spacer interposed between the valve seat and the hub for axially spacing the valve seat from the valve member at the normally open position to fix the prescribed flow rate at which the excess flow valve closes.

According to another aspect, a fluid delivery system includes a fluid storage tank for storing fluid within an interior of the tank, the fluid storage tank having a tank outlet through which fluid in the tank is dispensed. The fluid delivery system also includes an excess flow valve including an inlet in communication with the interior of the tank and a valve member movable between an open position permitting flow of fluid from the fluid storage tank through the valve and a closed position blocking flow of fluid through the valve, wherein the valve member is disposed in a lower half of the fluid storage tank.

The valve member may be disposed in the lower quarter of the fluid storage tank.

The valve member may be disposed adjacent an internal bottom surface of the fluid storage tank.

The valve member in a normally open position may be responsive to flow through the excess flow valve from the fluid storage tank, the valve member being movable along a valve member axis to a closed position at a prescribed amount of flow across the valve member to close the excess flow valve.

The fluid delivery system may further include an extension tube disposed in the fluid storage tank, wherein the tank outlet is disposed at a top of the fluid storage tank, and wherein the extension tube extends between the tank outlet and the flow valve outlet.

According to yet another aspect, an excess flow valve includes a tubular body having a flow valve outlet for dispensing fluid from the excess flow valve, a flow valve inlet for receiving fluid into the excess flow valve, and an internal chamber extending therebetween. The excess flow valve also includes an annular valve seat disposed in the internal chamber and defining an inner passage for directing flow through the internal chamber. The excess flow valve further includes a valve member disposed on an upstream side of the valve seat in a normally open position and responsive to flow through the excess flow valve, the valve member being movable along a valve member axis to a closed position to engage the valve seat to close the excess flow valve at a prescribed amount of flow across the valve member. A first cross-sectional area between an outer diameter of the valve member and an inner diameter of the tubular body at the open position of the valve member is greater than a smallest second cross-sectional area through the inner passage at the open position of the valve member.

The first cross-sectional area may remain uniform over an axial distance between the open position and the closed position at least until a third cross-sectional area between an outer diameter of the valve member and an inner diameter of the valve seat equals the first cross-sectional area.

The excess flow valve may further include a hub disposed in the internal chamber and having a central guide for guiding the valve member and flow passages for allowing flow through the hub, and a tubular spacer interposed between the valve seat and the hub for axially spacing the valve seat from the valve member at the normally open position, to fix the prescribed flow rate at which the excess flow valve closes.

The tubular body may be cylindrical, and the inner diameter of the tubular body may be uniform over an axial distance between the open position and the closed position.

An inlet end of the tubular body may extend along the valve member axis beyond the open position of the valve member.

The foregoing and other features of the invention are hereinafter described in greater detail with reference to the accompanying drawings.

### BRIEF DESCRIPTION OF THE DRAWINGS

FIG. 1 is a partial side elevational view of an exemplary fluid delivery system according to the invention.

FIG. 2 is a perspective view of an exemplary shutoff valve assembly for use in the exemplary fluid delivery system of FIG. 1.

FIG. 3 is a cross-sectional elevational view of the exemplary shutoff valve assembly taken about line 3-3 in FIG. 2.

FIG. 4 is a partial cross-sectional elevational view of the exemplary shutoff valve assembly of FIG. 2.

FIG. 5 is another partial cross-sectional elevational view of the exemplary shutoff valve assembly of FIG. 2.

### DETAILED DESCRIPTION

The principles of the present application have particular application to shutoff valve assemblies in agricultural fluid delivery systems that deliver a fluid, such as liquid anhydrous ammonia. It will of course be appreciated, and also understood, that the principles of the invention may be useful in other fluid applications where it is desirable to stop uncontrolled flow of fluid through a conduit.

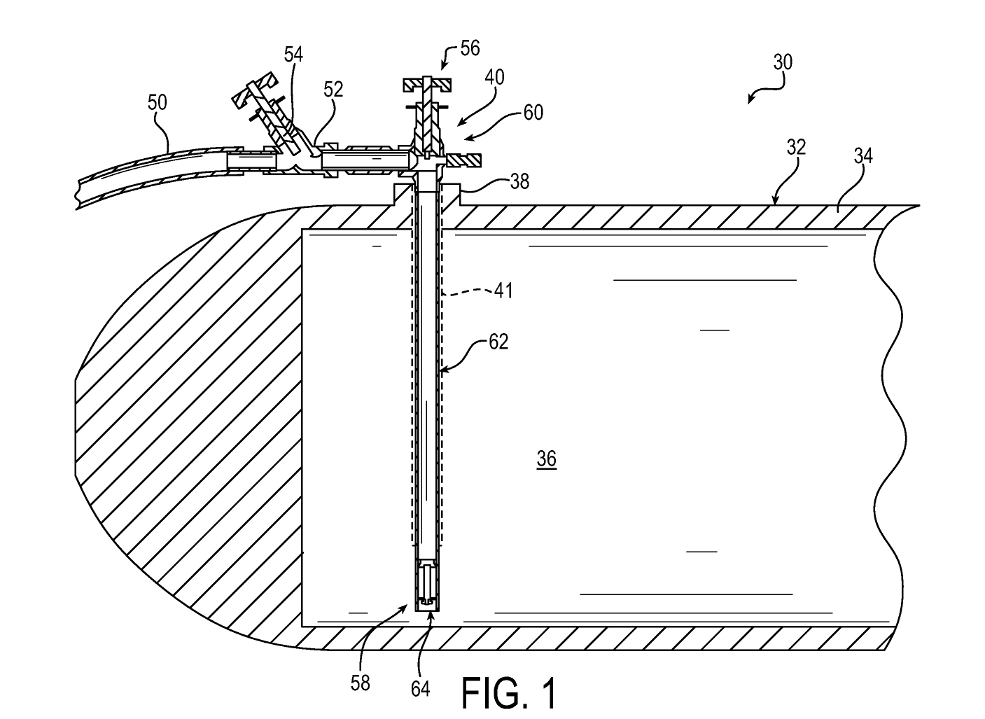

Referring now in detail to the drawings, and initially to FIG. 1, a fluid delivery system is shown at 30 and includes a fluid container, such as a nurse tank 32. The nurse tank 32 is configured to hold a pressurized fluid, such as pressurized gas, liquid, or a combination thereof. The nurse tank 32 includes a tank body 34 defining an internal space 36 for receiving the pressurized fluid and a tank coupling 38 which may be formed integrally with the tank body 34 as shown or removably coupled to the tank body 34.

The tank coupling 38 defines a tank outlet for dispensing fluid from the tank 32. As shown, the tank coupling 38 is disposed at a top of the nurse tank 32, although the tank coupling 38 may be otherwise suitably located in other embodiments. The tank coupling 38 may include threads, such as internal threads, for threaded coupling to a valve or valve assembly, such as a shutoff valve assembly 40, for controlling flow of fluid from the nurse tank 32.

The shutoff valve assembly 40 may extend into a dip tube 41 (shown in broken lines) of the nurse tank 32, and the dip tube 41 may extend internally into the internal space 36, such as extending from a portion of the tank body 34 adjacent the tank coupling 38. The dip tube 41 may be integral with the nurse tank 32 or alternatively otherwise suitably attached to the tank 32, such as by welding or threading.

The shutoff valve assembly 40 extends at least partially into the internal space 36 of the nurse tank 32 for providing a path for flow of fluid from the nurse tank 32. The shutoff valve assembly 40 is configured to automatically close upon an excessive downstream pressure release, such as in the case of a line break, to prevent excessive amounts of fluid from escaping from the nurse tank 32.

A conduit, such as a delivery line 50, is fluidly coupled to the shutoff valve assembly 40 for providing a path for fluid to flow away from the nurse tank 32. A manual shutoff valve 52 is coupled between the delivery line 50 and the shutoff valve assembly 40 in any suitable manner, such as by a removable connection. In some embodiments the manual shutoff valve 52 may be integral with at least the delivery line 50. A valve member 54 of the manual shutoff valve 52 is closed prior to disconnecting the delivery line 50 from the shutoff valve assembly 36 and the nurse tank 32, which maintains fluid within the delivery line 50 without the fluid escaping upon the disconnection. After connection of the delivery line 50 and manual shutoff valve 52 to the shutoff valve assembly 40, both the shutoff valve assembly 40 and manual shutoff valve 52 may be opened to allow fluid flow from the nurse tank 32 to the delivery line 50.

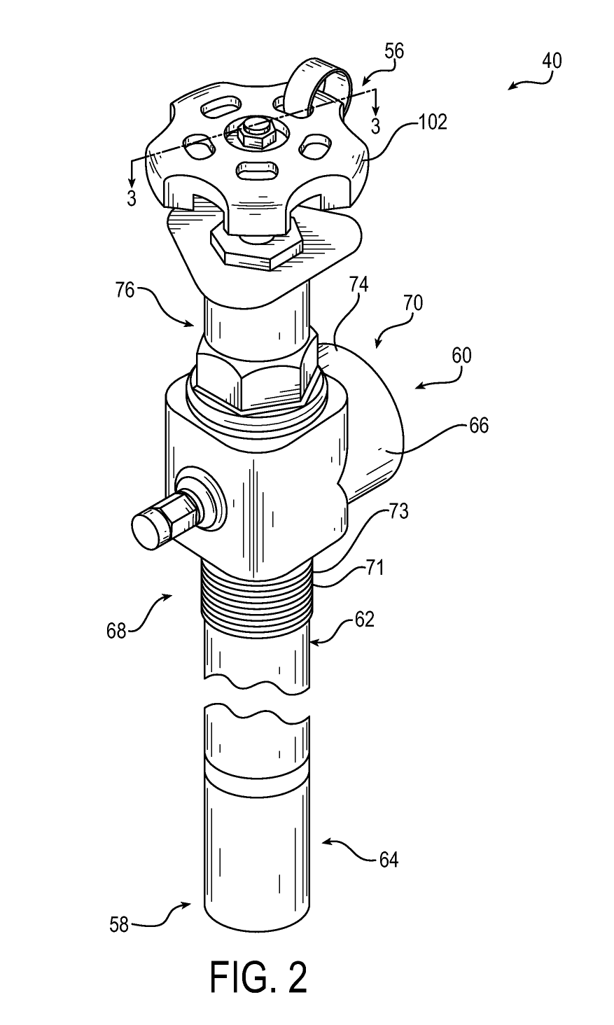

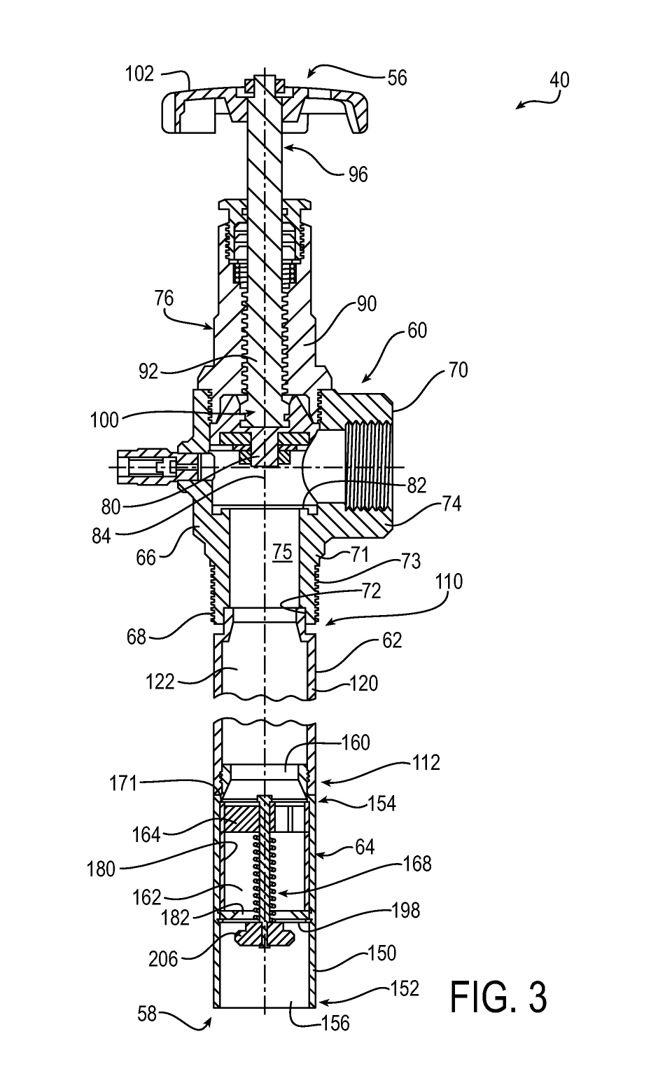

As shown in FIGS. 2 and 3 in addition to FIG. 1, the shutoff valve assembly 40 extends between an upper end 56 and a lower end 58, and may include a shutoff valve 60, an extension tube 62, and an excess flow valve 64.

The shutoff valve 60, extension tube 62, and excess flow valve 64 are removably coupled to one another, and to the nurse tank 32, although any of the shutoff valve 60, extension tube 62, and excess flow valve 64 may be integral with the other of the shutoff valve 60, extension tube 62, and excess flow valve 64. Any of the nurse tank 32, shutoff valve 60, extension tube 62, and excess flow valve 64 may be coupled to one another by any suitable method, such as by welding, adhesives, threads, etc.

The shutoff valve 60 includes a main valve body 66 having a main inlet end 68 and a main outlet end 70 for coupling to another component, such as the manual shutoff valve 52. The main inlet end 68 is defined by a coupling, such as a first tubular collar 71 for coupling, such as removably coupling, to the tank coupling 38 and to the extension tube 62 or another suitable component. As shown, the first tubular collar 71 includes internal threads 72 for threaded coupling to corresponding threads of the extension tube 64, and external threads 73 for threaded coupling to the tank coupling 38. In some embodiments the first tubular collar 71 may include additional external threads for threaded coupling to the extension tube 62. The main outlet end 70 is defined by another coupling, such as a second tubular collar 74, which may have threads for enabling threaded coupling to corresponding threads of the manual shutoff valve 52. A main flow passage 75 extends between the main inlet end 68 and the main outlet end 70 and is defined by the main valve body 66.

The shutoff valve 60 also includes a bonnet assembly 76 coupled, such as removably coupled, to the main valve body 66, although the bonnet assembly 76 may also be integral with the main valve body 66. The main valve body 66 and the bonnet assembly 76 each include corresponding threads for enabling the coupling, although the main valve body 66 and the bonnet assembly 76 may be coupled by other methods, such as welding, adhesives, etc. The bonnet assembly 76, and thus the shutoff valve 60, includes a main valve member 80 that extends at least partially into the main flow passage 75 for opening and closing the main flow passage 75. The main valve member 80 is movable along a main valve axis 84 to engage a main valve seat 82, thereby closing the main flow passage 75 and stopping flow through the shutoff valve assembly 40. The main valve seat 82 at least partially defines the main flow passage 75 and is defined by the main valve body 66.

The bonnet assembly 76 also includes a bonnet body 90 for at least partially receiving a bonnet shaft 92 engaged thereto, such as by corresponding threads on each of the bonnet body 90 and bonnet shaft 92. The bonnet shaft 92 extends between an external end 96, extending outwardly from the bonnet body 90, to an internal end 100 to which the main valve member 80 is coupled. An engagement member, such as a handle 102, is coupled to the external end 96 of the bonnet shaft 92. Rotation of the handle 102, and thus the bonnet shaft 92, about the main valve axis 84 causes axial translation of the bonnet shaft 92 relative to the bonnet body 90 and along the main valve axis 84. The main valve member 80 is thus caused to engage the main valve seat 82 of the shutoff valve 60.

Coupled to the main inlet end 68 of the shutoff valve 60 is the extension tube 62. The extension tube 62 extends away, such as axially downwardly away, from the main inlet end 68 and defines a flow path extending between the main inlet end 68 and the lower end 58 of the shutoff valve assembly 40. The extension tube 62 includes a body, such as a tubular body 120 having upper and lower ends 110 and 112 and a flow path 122 extending therebetween that fluidly couples the shutoff valve 60 to the excess flow valve 64. The extension tube 62 extends between the tank outlet of the nurse tank 32 and an outlet of the excess flow valve 64. As shown, the upper end 110 of the extension tube is coupled to the shutoff valve 60, such as by a threaded connection, and the lower end 112 is coupled to the excess flow valve 64, such as by a threaded connection.

The excess flow valve 64, including the inlet of the shutoff valve assembly 40, is disposed in the flow path 122 of the extension tube 62, and may be configured to close upon a drop in pressure across the excess flow valve 64. The pressure drop may be caused, for example, by excess flow (flow in excess of normal flow) through the excess flow valve 64, in turn caused by a downstream line break, such as external to the nurse tank 32, such as a break in the delivery line 50 of the fluid delivery system 30. In the case of such a break, both gas and liquid phases of the fluid in the nurse tank 32 will be exhausted or will escape from the nurse tank 32 through the shutoff valve assembly 40 and through the delivery line 50.

The use of the extension tube 62 enables an inlet of the shutoff valve assembly 40, such as a flow valve inlet 156 of the excess flow valve 64, to be disposed in a lower portion of the filled internal space 36 below a flash interface of a fluid in the nurse tank 32. The flash interface is the fluid section of a filled fluid tank separating a liquid phase of the fluid from a gas phase of the fluid. The flash interface includes a mixture of both gas and liquid phases of the fluid and lowers within a filled fluid tank as the tank is emptied of the fluid.

When the excess flow valve 64 and the flow valve inlet 156 are exposed to the liquid phase of the fluid below the flash interface, the rapid flow of liquid fluid through the excess flow valve 64 causes a pressure drop across the excess flow valve 64 to close the excess flow valve 64. Due to the configuration of the extension tube 62, the excess flow valve 64 is not substantially exposed to the gas phase of the fluid above the flash interface or within the flash interface itself. Flow of the gas phase of the fluid through the excess flow valve 64 may not be sufficient to cause a great enough pressure drop across the excess flow valve 64 to close the excess flow valve 64. As compared to flow of liquid fluid through the excess flow valve 64, flow of gaseous fluid thereby may enable fluid to continue to escape unwantedly.

Accordingly, the extension tube 62 is configured, such as having a shape and/or length, for locating the flow valve inlet 156 below the flash interface of fluid in the nurse tank 32 while the nurse tank 32 is fully filled, nearly empty, and various states therebetween. For example, the flow valve inlet 156 may be disposed in a lower half of the nurse tank 32, preferably in a lower quarter of the nurse tank 32, more preferably in a lower eighth of the nurse tank, and even more preferably located adjacent an internal bottom surface of the nurse tank 32. For example, the flow valve inlet 156 may be located within the internal space 36 within a range of zero to five inches from a bottom internal surface of the nurse tank 32, or more particularly within a range of zero to two inches from the bottom internal surface of the nurse tank 32. The inlet of the shutoff valve assembly 40 thereby may be disposed only within the liquid phase of the fluid in the nurse tank 32 during normal use of the fluid delivery system 30, which does not typically include fully emptying the nurse tank 32 of the fluid.

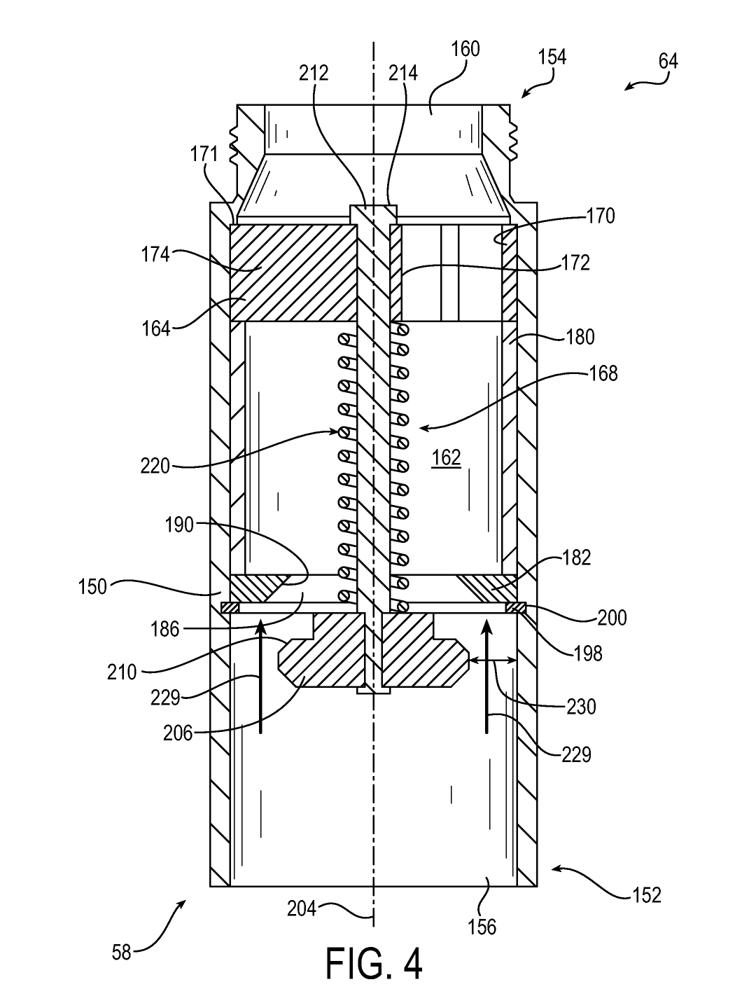

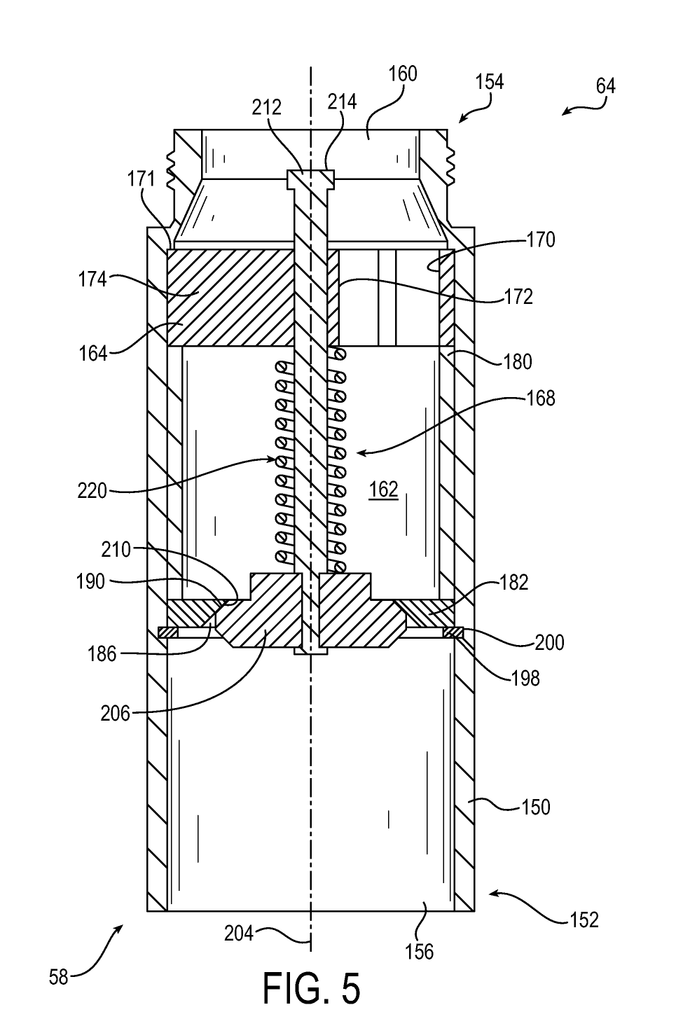

Turning now to FIGS. 4 and 5, the excess flow valve 64 of the shutoff valve assembly 40 is shown in greater detail. The excess flow valve 64 includes a tubular body 150 having a first (upstream) end 152 and a second (downstream) end 154, and an internal chamber 162 defined therebetween. The excess flow valve 64 also includes a hub 164 such as a spring base, an internal valve assembly 168, a spacer 180 and a valve seat 182. The first end 152 defines a flow valve inlet 156 that is the inlet for fluid flow into the excess flow valve 64 and into the shutoff valve assembly 40. The second end 154 defines a flow valve outlet 160 for communicating with the main inlet end 68 of the shutoff valve 60. The second end 154 is coupled to the lower end 112 of the extension tube 62, such as by a threaded connection. The flow valve outlet 160 is fluidly connected to the tank valve outlet of the nurse tank 32.

The spring base 164 is received in an internal chamber 162 of the extension tube 62 and is disposed at the second end 154 of the tubular body 150. The spring base 164 supports the valve assembly 168, which is responsive to flow through the excess flow valve 64 to close the excess flow valve 64 as discussed in detail below. As shown, the spring base 164 removably engages the tubular body 150, and may be coupled to the tubular body 150 in any suitable manner, such as by threads, welding, adhesive, etc. It will be appreciated however that the spring base 164 may be integral with the tubular body 150.

The spring base 164 includes an outer portion 170, an inner hub portion 172, and extensions, such as legs 174, extending therebetween. The outer portion 170 is substantially cylindrical, engages an internal surface of the tubular body 150, and is positioned in the internal chamber 162 via its engagement with a shoulder 171 of the tubular body 150. The shoulder 171 is disposed at the downstream end 154 and at least partially defines the internal chamber 162. The inner hub portion 172 is inwardly radially spaced from the outer portion 170, such as concentric with the outer portion 170. The inner hub portion 172 is substantially cylindrical and receives at least a portion of the valve assembly 168 therein. A plurality of circumferentially spaced legs 174 extend between the inner hub portion 172 and the outer portion 170, defining flow passages through the spring base 164, to enable fluid flow between the first and second ends 152 and 154.

Also received in the internal chamber 162 is the spacer 180, which is tubular in shape and defines a pathway for fluid flow through the spacer 180. The spacer 180 engages an upstream surface of the spring base 164 and an internal surface of the tubular body 150, and in the depicted embodiment is configured to provide the greatest amount of area for flow through the spacer 180. It will be appreciated however that the spacer 180 may be further inwardly radially spaced from the internal surface of the tubular body 150. The spacer 180 is disposed between the spring base 164 and the valve seat 182. A length of the spacer 180 between the first and second ends 152 and 154 is configured to position the valve seat 182 at a particular location along a longitudinal length of the tubular body 150.

The valve seat 182 is shown as an annular valve seat and is disposed in the internal chamber 162. The valve seat 182 defines an inner passage 186 directing flow through the tubular body 150. An inner annular surface 190 of the valve seat 182 at least partially defines the inner passage 186 and is engaged by the valve assembly 168 to close the excess flow valve 64, preventing flow through the shutoff valve assembly 40. The surface 190 is angled in an upstream direction such that an upstream end of the inner passage 186 has a larger cross-sectional area than a downstream end of the inner passage 186. The inner annular surface 190 may be disposed at a suitable angle, such as a forty-five degree angle relative to an internal surface of the tubular body 150, although the surface 190 may instead be sloped or have any other suitable shape for engaging the valve assembly 168.

The valve seat 182 is coupled in the tubular body 150 between the spacer 180 and a retainer, such as a cylindrical snap-ring 198, thereby maintaining a position of the valve seat 182 along a longitudinal length of the tubular body 150 between the first and second ends 152 and 154. As shown, the snap-ring 198 is at least partially received in a recess 200 in an internal surface of the tubular body 150. Alternatively, at least one of the valve seat 182 or the snap-ring 198 may be integral with the tubular body 150 and/or may be threadedly coupled to the tubular body 150 or attached by another method, such as via welding, adhesives, etc. It will be appreciated that the valve seat 182 and the snap-ring 198 may be of any other suitable shape. Via engagement of the snap-ring 198 with the tubular body 150, the annular valve seat 182, tubular spacer 180, and spring base 164 are relatively positioned within the internal chamber 162 along the longitudinal length of the tubular body 150, between the first and second ends 152 and 154 of the excess flow valve 64.

The valve assembly 168 moves relative to the valve seat 182 to engage the valve seat 182 and close the excess flow valve 64. The valve assembly 168, shown in the depicted embodiment as a poppet assembly 168, extends along a valve member axis 204, such as a poppet axis 204, coaxial with axis 84 and through each of the tubular body 150, spring base 164, spacer 180, valve seat 182, and snap-ring 198. The valve member axis 204 is centrally disposed relative to the internal chamber 162 and extends along the longitudinal length of the tubular body 150, between the first and second ends 152 and 154.

The valve assembly 168 includes a valve member 206, such as a poppet 206 with a valve stem 212 and a resilient member 220. The valve member 206 is movable along the valve member axis 204 between a normally open position allowing fluid flow through the excess flow valve 64, and a closed position where the valve member 206 engages the valve seat 182 to close the excess flow valve 64. The length of the spacer 180 may be configured or adjusted to alter the prescribed distance between the valve seat 182 and the valve member 206 at the normally open position, thereby fixing the prescribed flow rate range at which the excess flow valve 64 closes. Alternatively, spacers 180 of different lengths may be used to alter the prescribed flow rate range.

The valve member 206 is disposed at an upstream side of the valve seat 182 at the inlet end 152 of the tubular body 150. The valve member 206 includes an engagement surface 210 at a downstream side of the valve member 206 for engaging the mating surface 190 of the valve seat 182. As shown, the engagement surface 210 may be disposed at a forty-five degree angle relative to the valve member axis 204, such as to correspondingly engage the mating surface 190. Alternatively, the engagement surface 210 may instead be sloped or have any other suitable shape for engaging the mating surface 190.

The valve member stem 212 extends in a downstream direction from the valve member 206 along the valve member axis 204. The valve member stem 212 is removably attached to the valve member 206, such as by a threaded connection. Alternatively, the valve member stem 212 and the valve member 206 may be integral with one another or attached via any other method, such as via welding, adhesives, etc. The valve member stem 212 is received in the inner hub portion 172 of the spring base 164. A boss 214 is disposed at a downstream end of the valve member stem 212 for maintaining axial engagement of the valve member stem 212 in the inner hub portion 172.

The resilient member 220, such as a biasing spring is disposed about the valve member stem 212 and extends between an upstream side of the spring base 164 and a downstream side of the valve member 206 to bias the valve member 206 in the normally open position. Alternatively, the resilient member may be any other suitable member for biasing the valve member 206 in a normally open position.

In the normally open position shown in FIG. 4, the valve member 206 is axially separated along the valve member axis 204 from the valve seat 182. Upon normal flow through the excess flow valve 64, and thus through the shutoff valve assembly 40, a biasing force of the biasing spring 220 overcomes a force created by the normal flow of fluid across the valve member 206, and thus across the valve assembly 168. On the other hand, the valve assembly 168, including the valve member 206 and biasing spring 220, is configured to close the excess flow valve 64 where excess flow into the inlet end 152 and through the excess flow valve 64 creates increased force acting on the valve member 206.

For example, in the case of a downstream line break causing excess flow through the excess flow valve 64, the force of the excess flow across the valve member 206 will create a pressure drop across the valve member 206 overcoming the biasing force of the biasing spring 220. The valve member 206 and the valve member stem 212 will move axially along the valve member axis 204 in the downstream direction. The valve member 206 will move axially towards the valve seat 182, thereby causing the engagement surface 210 to engage the mating surface 190. In this way, the valve member 206 will be moved to the closed position shown in FIG. 5, closing the excess flow valve 64 and preventing flow through the shutoff valve assembly 40.

To achieve closing of the excess flow valve 64 while the nurse tank 32 is fully filled, nearly empty, and various states therebetween, the flow valve inlet 156 and preferably the valve seat 182 and/or the valve member 206 are disposed below the flash line of an associated tank, such as the nurse tank 32. Accordingly, the valve seat 182 and/or the valve member 206 may be disposed in a lower half of the nurse tank 32, preferably in a lower quarter of the nurse tank 32, more preferably in a lower eighth of the nurse tank, and even more preferably located adjacent an internal bottom surface of the nurse tank 32. For example, the valve seat 182 and/or the valve member 206 may be located within the internal space 36 within a range of zero to five inches from a bottom internal surface of the nurse tank 32, or more particularly within a range of zero to two inches from the bottom internal surface of the nurse tank 32. The valve member 206 at the closed position thereby may be disposed only within the liquid phase of the fluid in the nurse tank 32 during normal use of the fluid delivery system 30, which does not typically include fully emptying the nurse tank 32 of the fluid.

In use, the excess flow valve 64 enables the shutoff valve assembly 40 to repeatedly close at a relatively small flow rate range. Additionally, a plurality of shutoff valve assemblies 40 will each close within the relatively small flow rate range, providing a relatively repeatable closing flow rate range when comparing a first shutoff valve assembly 40 to another shutoff valve assembly 40.

As shown in FIGS. 4 and 5, the tubular body 150 extends in an upstream direction beyond the normally open position of the valve member 206. In this way, an upstream flow path 229 defined by an annular cross-sectional flow area disposed between an outermost diameter of the valve member 206 and an innermost diameter of the tubular body 150, such as a radial gap 230, may be substantially uniform regardless of a nurse tank into which the shutoff valve assembly 40 is inserted. The substantial uniformity enables the valve member 206 to close at a repeatable flow rate range. This construction prevents fluid from flowing around the valve member 206 and providing force acting in an upstream direction on a downstream side of the valve member 206, thus countering force of fluid flow in the downstream direction across the valve member 206 and preventing the excess flow valve 64 from closing.

Additionally, a nurse tank for use in conjunction with the shutoff valve assembly 40 may include the dip tube 41 extending into the internal space of the nurse tank. The dip tube 41 may become rusted, corroded, or misshapen over time and thus the internal diameter of the dip tube 41 may gradually change. Also, the internal diameter of a dip tube of one nurse tank may be different from an internal diameter of a dip tube of another nurse tank. In these situations, an upstream flow path 229 interposed between the outermost diameter of the valve member 206 and the innermost diameter of the tubular body 150 will be substantially uniform without regards to the nurse tank and/or dip tube into which the shutoff valve assembly 40 is inserted.

The upstream flow path 229 is uniform over a substantial portion of an axial distance between the normally open position and the closed position of the valve member 206. This uniform flow path 229 defines a first cross-sectional area, which is the radial gap 30, and which is disposed along the valve member axis 204. This first cross-sectional area is substantially annular and is defined through a plane orthogonal to and intersecting valve member axis 204. The uniformity of the flow path 229 enables the excess flow valve 64 to close at a prescribed and repeatable range of flow across the valve member 206. For example, the depicted tubular body 150 is cylindrical, and the inner diameter of the tubular body 150 and the outermost diameter of the valve member 206 are each uniform as the valve member 206 moves along the flow path 229. The closing flow rate of the excess flow valve 64 is thus prevented from varying depending on the axial distance of the valve member 206 from the valve seat 182 over the axial distance of the flow path 229.

The first cross-sectional area of the upstream flow path 229 remains uniform and extends over an axial distance between the normally open position and the closed position of the excess flow valve 64, at least until an auxiliary cross-sectional area between an outer diameter of the valve member 206 and an inner diameter of the valve seat 182 equals the cross-sectional area of the upstream flow path 229 (between the outermost diameter of the valve member 206 and the inner diameter tubular body 150). The auxiliary cross-sectional area is disposed along the valve member axis 204 upstream of the final closed position of the valve member 206. The auxiliary cross-sectional area is disposed between an outer diameter of the valve member 206 and an inner diameter of the annular valve seat 182. The auxiliary cross-sectional area may be annular in shape and is defined through a plane orthogonal to and intersecting valve member axis 204. The auxiliary cross-sectional area is defined by any outer diameter of the valve member 206 and any inner diameter of the valve seat 182 which during movement of the valve member 206 towards the valve seat 182 first forms a cross-sectional area equal to the first cross-sectional area.

After moving through the upstream flow path 229, the valve member 206 will reach the auxiliary cross-sectional area, after which the valve member 206 will continue to move closer to engagement with the valve seat 182 due to increased flow through the excess flow valve 64. After reaching the auxiliary cross-sectional area, momentum of the valve member 206 will continue to close the excess flow valve 64, and variance in the flow rate necessary to close the excess flow valve 64 will be generally negated by such momentum.

Additionally, at the normally open position of the valve member 206, the smallest cross-sectional area (greatest flow restriction) through the excess flow valve 64 and through a plane orthogonal to and intersecting the valve member axis 204 occurs upstream of the valve seat 182. In other words, in the case of the excess flow valve 64, the flow restriction (or smallest cross-sectional area across the excess flow valve 64, either at the open position of the valve member 206 or through the axial distance previously defined along the flow path 229) is disposed upstream of the valve seat 182. Therefore, such a smallest cross-sectional area through the inner passage 186 and across the valve seat 182 is greater in size than the flow restriction cross-sectional area along the path 229—between the outermost diameter of the valve member 206 and the innermost diameter of the tubular body 150 either at the open position of the valve member 206 or along the axial distance between the first cross-sectional area and the auxiliary cross-sectional area.

In this way, the prescribed amount of flow at which the excess flow valve 64 closes is controlled by the relationship between the movable valve member 206 and the tubular body 150, and not by a flow restriction downstream of the valve seat 182. Thus the prescribed amount of flow is repeatable over a plurality of repeated closings, and chatter of the valve member 206 is reduced. Chatter is defined as rapid and repetitive engagement and disengagement of the valve member with the valve seat, causing repetitive opening and closing of the excess flow valve, thereby enabling flow to continue through the excess flow valve, even during an excess flow condition.

Also due to the uniform relationship between the valve member 206 and the tubular body 150, reduction of the length of the tubular spacer 180 is sufficient to increase the prescribed flow rate range at which the excess flow valve 64 closes, and vice versa. The length of the spacer 180 may be configured or adjusted to alter the prescribed distance between the valve seat 182 and the valve member 206 at the normally open position, thereby fixing the prescribed flow rate range at which the excess flow valve 64 closes.

In summary, the shutoff valve assembly 40 includes a shutoff valve 60, an extension tube 62 extending from the shutoff valve 60 and an excess flow valve 64 located at a lower end 112 of the extension tube 62. The excess flow valve 64 includes a valve member 206 in a normally open position and responsive to flow into the excess flow valve 64 to close the excess flow valve 64. A tubular body 150 of the excess flow valve 64 receives the valve member 206, and defines a radial gap 230 between an inner diameter of the tubular body 150 and an outer diameter of the valve member 206, where the radial gap 230 is uniform over an axial distance between the open position and a closed position of the valve member 206. The shutoff valve assembly 40 may be used in combination with a fluid storage tank 32 for storing fluid and an excess flow valve inlet 156 may be disposed adjacent an internal bottom surface of the tank 32.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A shutoff valve assembly comprising:
a shutoff valve including a main valve body having a main inlet end and a main outlet end and defining a main flow passage therebetween, and a valve member for opening and closing the main flow passage;
an extension tube extending between an upper end and a lower end; and
an excess flow valve located at the lower end of the extension tube, the excess flow valve including a valve member in a normally open position and responsive to flow through the excess flow valve, the valve member being movable along a valve member axis to a closed position at a prescribed amount of flow across the valve member to close the excess flow valve.

2. The shutoff valve assembly of claim 1, wherein the excess flow valve further includes a tubular body coupled to the extension tube and having the valve member disposed therein.

3. The shutoff valve assembly of claim 2, wherein an inlet end of the tubular body extends along the valve member axis beyond the open position of the valve member.

4. The shutoff valve assembly of claim 1, wherein the excess flow valve is removably coupled to the extension tube.

5. The shutoff valve assembly of claim 1, wherein the extension tube is removably coupled to the shutoff valve.

6. The shutoff valve assembly of claim 1, wherein the main valve body includes a tubular collar having external main threads for engaging a fluid storage tank, and internal main threads for engaging the extension tube.

7. The shutoff valve assembly of claim 1, in combination with a fluid storage tank for storing fluid, wherein the extension tube is configured such that an inlet end of the excess flow valve is disposed adjacent an internal bottom surface of the fluid storage tank.

8. The shutoff valve assembly of claim 2,
wherein the excess flow valve further includes an annular valve seat disposed in the tubular body and defining an inner passage for directing flow through the tubular body, and
wherein a first cross-sectional area between an outer diameter of the valve member and an inner diameter of the tubular body at the open position of the valve member is greater than a smallest second cross-sectional area through the inner passage at the open position of the valve member.

9. The shutoff valve assembly of claim 2,
wherein the excess flow valve further includes an annular valve seat disposed in the tubular body and defining an inner passage for directing flow through the tubular body, and
wherein a first cross-sectional area between an outer diameter of the valve member and an inner diameter of the tubular body at the open position of the valve member remains uniform over an axial distance between the open position and the closed position at least until a third cross-sectional area between the outer diameter of the valve member and an inner diameter of the valve seat equals the first cross-sectional area.

10. The shutoff valve assembly of claim 2, wherein the tubular body is cylindrical, and
wherein the inner diameter of the tubular body is uniform over an axial distance between the open position and the closed position.

11. The shutoff valve assembly of claim 1, further including
an annular valve seat, the valve member being movable relative to the valve seat and engaging the valve seat at the closed position,
a hub having a central guide for guiding the valve member, and
a tubular spacer interposed between the valve seat and the hub for axially spacing the valve seat from the valve member at the normally open position to fix the prescribed flow rate at which the excess flow valve closes.

12. A fluid delivery system comprising:
a fluid storage tank for storing fluid within an interior of the tank, the fluid storage tank having a tank outlet through which fluid in the tank is dispensed; and
an excess flow valve including an inlet in communication with the interior of the tank and a valve member movable between an open position permitting flow of fluid from the fluid storage tank through the valve and a closed position blocking flow of fluid through the valve, wherein the valve member is disposed in a lower half of the fluid storage tank.

13. A fluid delivery system of claim 12, wherein the valve member is disposed in the lower quarter of the fluid storage tank.

14. A fluid delivery system of claim 12, wherein the valve member is disposed adjacent an internal bottom surface of the fluid storage tank.

15. The fluid delivery system of claim 12, wherein the valve member in a normally open position is responsive to flow through the excess flow valve from the fluid storage tank, the valve member being movable along a valve member axis to a closed position at a prescribed amount of flow across the valve member to close the excess flow valve.

16. The fluid delivery system of claim 12, further including an extension tube disposed in the fluid storage tank, wherein the tank outlet is disposed at a top of the fluid storage tank, and wherein the extension tube extends between the tank outlet and the flow valve outlet.

17. An excess flow valve comprising:
a tubular body having a flow valve outlet for dispensing fluid from the excess flow valve, a flow valve inlet for receiving fluid into the excess flow valve, and an internal chamber extending therebetween;
an annular valve seat disposed in the internal chamber and defining an inner passage for directing flow through the internal chamber; and
a valve member disposed on an upstream side of the valve seat in a normally open position and responsive to flow through the excess flow valve, the valve member being movable along a valve member axis to a closed position to engage the valve seat to close the excess flow valve at a prescribed amount of flow across the valve member,
wherein a first cross-sectional area between an outer diameter of the valve member and an inner diameter of the tubular body at the open position of the valve member is greater than a smallest second cross-sectional area through the inner passage at the open position of the valve member.

18. The excess flow valve of claim 17, wherein the first cross-sectional area remains uniform over an axial distance between the open position and the closed position at least until a third cross-sectional area between an outer diameter of the valve member and an inner diameter of the valve seat equals the first cross-sectional area.

19. The excess flow valve of claim 17, further including
a hub disposed in the internal chamber and having a central guide for guiding the valve member and flow passages for allowing flow through the hub, and
a tubular spacer interposed between the valve seat and the hub for axially spacing the valve seat from the valve member at the normally open position, to fix the prescribed flow rate at which the excess flow valve closes.

20. The excess flow valve of claim 17,
wherein the tubular body is cylindrical, and
wherein the inner diameter of the tubular body is uniform over an axial distance between the open position and the closed position.
